(19) United States
(12) Patent Application Publication
(10) Pub. No.: US 2025/0242423 A1
(43) Pub. Date: Jul. 31, 2025

(54) Device For Transporting An Object For A Grinding Machine

(71) Applicant: Reishauer AG, Wallisellen (CH)

(72) Inventors: Michel Muller, Uster (CH); Urs Bernhardsgrütter, Russikon (CH); Reto Weibel, Flawil (CH); Theo Hug, Wallenwil (CH)

(73) Assignee: Reishauer AG, Wallisellen (CH)

(21) Appl. No.: 18/848,790

(22) PCT Filed: Mar. 20, 2023
(86) PCT No.: PCT/EP2023/057077

§ 371 Date: Sep. 19, 2024

(30) Foreign Application Priority Data
Mar. 23, 2022 (CH) 000319/2022

(51) Int. Cl. B23F 23/04; B23F 23/12; B23Q 7/04

(52) U.S. Cl. CPC B23F 23/04; B23F 23/1225; B23Q 7/04

(57) ABSTRACT

A device for transporting an object to and/or from a grinding machine includes a base, a carrier arranged on the base and rotatable with respect to the base about a first axis of rotation, a swivel device arranged on the carrier for transporting the object. The swivel device is pivotable with respect to the carrier about a second axis of rotation, and the device is designed to carry out a rotational movement of the carrier about the first axis of rotation and a swivel movement of the swivel device about the second axis of rotation at least at times simultaneously in such a way that the object can be transported by means of a transport movement of the swivel device resulting from the superimposition of the rotational movement of the carrier with the swivel movement of the swivel device.

### TECHNICAL FIELD

The invention relates to a device for transporting an object to and/or from a grinding machine. The device comprises a base, a carrier and a swivel device. The carrier is arranged on the base and is rotatable with respect to the base about a first axis of rotation. The swivel device is arranged on the carrier and is designed to transport the object.

The invention further relates to a grinding machine for gear grinding a workpiece, wherein the grinding machine comprises a device of the above-mentioned type. In addition, the invention relates to a method for loading and unloading a grinding machine by means of a device according to the invention.

### BACKGROUND ART

So-called ring loader concepts are known from the state of the art. The devices according to the ring loader concept have a gripping device that is usually rotatable about an axis of rotation and comprises several pairs of gripper arms. Each pair of gripper arms is designed to grip or release a workpiece independently of the other pairs of gripper arms. In order to transport one or more workpieces, the gripping device is rotated about the axis of rotation after at least one pair of gripper arms has gripped a workpiece. As a result, all pairs of gripper arms, including the pair of gripper arms that have gripped a workpiece, are simultaneously swiveled around the axis of rotation.

Such devices known from the prior art have the disadvantage that the position of a pair of gripper arms in relation to another pair of gripper arms and in relation to the axis of rotation is fixed or cannot be changed due to the design of the gripping device. As a result, a workpiece can only ever be picked up or released for loading by the pairs of gripper arms at a fixed position or always at the same radial distance from the axis of rotation. The pairs of gripper arms cannot pick up workpieces flexibly at different positions. The same applies analogously to the positions at which the workpiece is released by the pairs of gripper arms during unloading. This leads to reduced or limited flexibility in the use of the known devices. The workpiece must regularly be centered for further processing after being released by a pair of gripper arms.

Another problem that arises with the known devices with regard to centering is that the dimensions of the axis of rotation are limited due to the fixed radial distance of the grippers from the axis of rotation. The relatively small dimensions of the axis of rotation result in a correspondingly reduced rigidity of the centering apparatus, which has a negative effect on the centering result and thus also on the workpiece quality.

The maintainability of the grinding machine is also limited with the known devices, especially as the gripping device is spatially fixed in relation to the grinding machine to be loaded and unloaded. The gripping devices known from the prior art are also not designed to transport replacement and/or accessory components to and/or from the grinding machine.

### SUMMARY OF THE INVENTION

The task of the invention is to provide a device for loading and unloading a grinding machine, which belongs to the technical field mentioned at the beginning and which eliminates the above-mentioned problems and disadvantages of the prior art. In particular, it is a task of the present invention to provide a device which enables both flexible loading and unloading of a grinding machine with workpieces.

To solve the problem, a device according to the invention, which is suitable for transporting an object to and/or from a grinding machine, comprises a base, a carrier and a swivel device. Preferably, the device is designed to transport an object to and/or from a gear grinding machine.

For the purposes of this application, the term “object” is generally understood to mean an object to be transported by the device. The “object” may, for example, be a workpiece, in particular a workpiece to be machined by the grinding machine. The workpiece can be a gear blank, in particular a pre-toothed gear blank. Preferably, the device is designed to load and unload the grinding machine with the workpiece.

Alternatively or additionally, the “object” can be a replacement component of the grinding machine. For example, the object can be a replacement workpiece spindle and/or a replacement grinding wheel for a grinding device of the grinding machine. Preferably, the device is designed to transport the replacement component to and/or from the grinding machine.

Alternatively or additionally, the “object” can be an accessory component of the grinding machine. For example, the object can be a dressing wheel, a tailstock tip, a cooling oil nozzle, a tool spindle, a clamping device, a dressing device and/or a grinding head. Preferably, the device is designed to transport the accessory component towards and/or away from the grinding machine.

Information storage elements may be arranged on the object, in particular on a workpiece, e.g. permanent optical elements or structural protrusions and/or indentations that enable the object to be identified. The elements may also include permanent or changeable data storages, e.g. RFIDs integrated into or arranged on the object. The elements can be read by a reading unit integrated into the device according to the invention or the grinding machine or units interacting therewith (e.g. setup trolley, AGV, etc.). Depending on the type of elements, such a reading unit comprises a camera, an RFID reading group and/or other components for detecting the elements. In the case of changeable data storages, their content can be changed as required by a corresponding integrated write unit. The reading unit and the writing unit can be combined in a single read/write unit.

In a preferred embodiment of the device according to the invention, the reading unit or read/write unit is arranged on the carrier and is able to read the elements arranged on the object while the object is held by the swivel device.

The stored information can include an identifier of the object, e.g. a unique identification number, and/or directly information on the geometry, processing status, use and/or other relevant aspects of the object. The read-out information can be stored in a local or central database, e.g. in a cloud-based database. It can, for example, be used during the processing of a workpiece or made available to subsequent users of the workpiece.

The carrier is arranged on the base and is rotatable with respect to the base about a first axis of rotation. The swivel device is arranged on the carrier and is designed to transport the object. In particular, the swivel device is designed to transport the object during loading and during unloading of the grinding machine. The swivel device is pivotable with respect to the carrier about a second axis of rotation.

The swivel device has a swivel means and a gripping device. The swivel means spaces the gripping device from the second axis of rotation in a radial direction. The gripping device is designed to grip or release the object. Such a swivel device has the advantage that the device is easy to manufacture and easy to maintain.

The swivel device comprises a swivel arm, which is the swivel means of the swivel device. The design of the swivel means as a swivel arm has the advantage that the swivel arm is simple and inexpensive to manufacture. At the same time, the radial spacing of the gripping device and/or the pick-up/feed device from the second axis of rotation is ensured in an effective manner.

The swivel arm is arranged on a holder so as to be pivotable about the second axis of rotation. The holder is arranged on the carrier, in particular movably arranged on the carrier. For example, the holder can be connected to the carrier in such a way that the holder can be moved axially in relation to the first axis of rotation and/or in relation to the second axis of rotation. Advantageously, the swivel arm is connected to the holder at a first end. The gripping device and/or the pick-up/feed device can be arranged at a second end of the swivel arm opposite the first end.

According to the invention, the device is designed to carry out a rotational movement of the carrier about the first axis of rotation and a swivel movement of the swivel device about the second axis of rotation at least at times simultaneously. As a result, the rotational movement of the carrier and the swivel movement of the swivel device are superimposed over at least a limited period of time. Advantageously, this causes the swivel device to undergo a transport movement resulting from the superimposition of the rotational movement of the carrier and the swivel movement of the swivel device. The transport movement of the swivel device can be used to transport the object for loading and unloading the grinding machine.

For the purposes of the present invention, the term “transport movement” is understood to mean a forced translation of an element with respect to the base. The “transport movement” is, for example, the translation of an element to be transported, in particular the object, from a first position to a second position that differs from the first position. For example, the first position may be a pick-up position at which the object is picked up by the device. The second position may, for example, be a position of use. The position of use can be a position at which the object can be processed by the grinding machine. This is the case, for example, if the object is a workpiece to be machined by the grinding machine. Additionally or alternatively, the position of use may be a position at which the object is used on the grinding machine. This is the case, for example, if the object is a spare and/or accessory component of the grinding machine. The object, preferably the workpiece, can be transported from the pick-up position to the position of use, in particular for loading the grinding machine by the device, preferably by the swivel device of the device.

Unless explicitly stated otherwise, an “axis of rotation” in the context of the present documents is a geometric axis. In principle, this can be realized by various constructive means, wherein these elements, e.g. mechanical axes, can comprise components in the area of the geometric axis and/or components spaced from the geometric axis, e.g. curved guides or similar.

For the sake of clarity, the term “rotational movement” in the following always refers to the rotational movement of the carrier about the first axis of rotation. In the following, the term “swivel movement” always refers to the swivel movement of the swivel device about the second axis of rotation. If other movements are meant or described by the terms “rotational movement” or “swivel movement”, this is explicitly mentioned at the relevant points.

The advantage of a transport movement resulting from the superimposition of the rotational movement with the swivel movement is that the object can be transported flexibly by the device. It is not only the transport path, i.e. the path on which the object moves during transport, that is flexible. The start and end points of the transport path can also be selected variably.

A further advantage of the present invention is that various components of the device can be made more accessible to a user by rotating the carrier about the first axis of rotation and/or by swiveling the swivel device about the second axis of rotation. This increases the maintainability of the entire device.

In addition, the carrier can be made larger or more massive by having an additional pivot axis to the axis of rotation. The same advantageously also applies to a centering device of the device. A larger dimensioned carrier and/or a larger dimensioned centering device results in a higher rigidity of the centering device. This in turn can lead to a better centering result and a higher workpiece quality if the object is a workpiece to be processed by the grinding machine.

The grinding machine can also comprise intermediate or auxiliary stations, e.g. for spinning the workpiece or for a finishing operation, e.g. chamfering and/or internal grinding. The workpiece can be spun using the workpiece spindle, and the carrier of the device according to the invention can be in a certain position or perform a rotational movement.

In a first exemplary embodiment, the first axis of rotation and the second axis of rotation are arranged relative to one another in such a way that the first axis of rotation and the second axis of rotation are spaced apart from one another. The distance between the first axis of rotation and the second axis of rotation can be fixed, i.e. not variable. A fixed distance between the first axis of rotation and the second axis of rotation means that the second axis of rotation moves on a circular path around the first axis of rotation when the carrier is rotated around the first axis of rotation. This has the advantage that the transport movement of the swivel device resulting from the superimposition of the rotational movement with the swivel movement can be easily controlled or regulated.

Alternatively, it is also conceivable that the distance between the first axis of rotation and the second axis of rotation is variable. The variability of the distance between the first axis of rotation and the second axis of rotation has the advantage of further increasing the number of possible transport movements. In particular, this increases the range or the transport distance that can be covered by the device. The variability in the choice of transport path can also be further increased by superimposing the change in distance with the rotational movement and the swivel movement.

In another exemplary embodiment, the second axis of rotation is displaced in parallel in relation to the first axis of rotation. For example, the second axis of rotation can be displaced in parallel to the first axis of rotation in a radial direction. This has the advantage that the transport movement of the swivel device resulting from the superimposition of the rotational movement with the swivel movement is easier to control or regulate.

In an exemplary further development, the rotational movement of the carrier about the first axis of rotation can be superimposed with the swivel movement of the swivel device about the second axis of rotation in such a way that the object can be moved by the device (at least in sections) along a rectilinear path. For example, the transport movement of the swivel device resulting from the superimposition of the rotational movement with the swivel movement can run along a rectilinear path. As a result, the object also undergoes a rectilinear transport movement. The transport movement of the object on a rectilinear path advantageously means that the object can be transported on the shortest transport path, in particular the direct transport path, during loading and unloading of the grinding machine. This has the advantage that the grinding machine can be loaded and unloaded more quickly by the device.

Another advantage may be that the device requires less space to transport the object. For example, an object can be picked up by the device and then transported along a rectilinear path towards the center of the device. Further transport of the object can then take place close to the center. If, for example, the first axis of rotation defines the center of the device, an object can first be moved along a rectilinear path in the direction of the first axis of rotation by superimposing the rotational movement with the swivel movement. Further transport can then take place, for example, by rotating the carrier around the first axis of rotation. The object is pivoted about the first axis of rotation close to the center, i.e. at a small radial distance from the first axis of rotation.

For this purpose, but also for other purposes, the device can be designed to carry out the rotational movement and the swivel movement selectively. This means that the carrier is rotatable about the first axis of rotation without the swivel device having to be swiveled about the second axis of rotation. Conversely, the swivel device can be pivotable about the second axis of rotation without the carrier having to be rotated about the first axis of rotation. This has the advantage that smaller position changes can be controlled and realized more easily.

In a further development of the aforementioned embodiment, the device can be designed to perform a rotational movement and a swivel movement in series. For example, it may be provided that the carrier is first rotated about the first axis of rotation and then the swivel device is swiveled about the second axis of rotation. Such a serial sequence of movements has the advantage that the device can be easily controlled or regulated.

The device can also be designed to perform a serial sequence of movements and a superimposed movement one after the other. This has the advantage that even complex transport operations can be realized by the device.

In a further exemplary embodiment of the device, the rotational movement of the carrier can be superimposed with the swivel movement of the swivel device in such a way that the object can be transported by the device from a pick-up area to a position of use. This is particularly advantageous for loading the grinding machine if the object is a workpiece.

In this context, a pick-up area is preferably a spatially limited area within which there may be a plurality of pick-up positions. For the purposes of the present invention, a “pick-up position” is understood to be a storage location or a staging location for an object to be transported by the device. Advantageously, the device is designed to be able to pick up at least one object from each of the pick-up positions within the pick-up area.

For example, the device can be designed to pick up a workpiece in the pick-up area, in particular at different pick-up positions, in order to load the grinding machine with the workpiece. Alternatively or additionally, the device can be designed to pick up a replacement and/or accessory component in the pick-up area, in particular at different pick-up positions, in order to transport the replacement and/or accessory component to the grinding machine.

The position of use can be a machining position if the object is a workpiece. For example, the machining position may be the position at which the workpiece to be machined is machined by the grinding machine. Advantageously, the device may be designed to feed the workpiece to be machined to the machining position at the end of a loading operation.

If the object is a replacement and/or accessory component, the position of use may be the position at which the replacement and/or accessory component is to replace another component and/or is to be arranged on the grinding machine.

Preferably, the position of use is also the position from which the object is to be transported away or removed by the device. This may be the case in particular at the beginning of an unloading operation. Preferably, the device is designed to be able to pick up the object, in particular a workpiece, a replacement component and/or an accessory component, at the position of use.

For unloading the grinding machine, the rotational movement of the carrier can be superimposed with the swivel movement of the swivel device in such a way that the workpiece can be transported by the device from the machining position to a delivery area. An analogous procedure is also conceivable if the object is a replacement component and/or an accessory component.

In this context, a delivery area is preferably a spatially limited area within which there can be a large number of delivery positions. For the purposes of the present invention, a “delivery position” is understood to be a storage location or a delivery location for an object transported by the device. Advantageously, the device is designed to be able to deliver the object at each of these delivery positions.

Preferably, the pick-up area and the delivery area are located together. This means that the pick-up area and the delivery area overlap at least to a large extent. For example, the pick-up area can correspond spatially to the delivery area. Advantageously, the pick-up area and the delivery area form a loading cell that is assigned to a circulating storage belt.

The pick-up area and/or the delivery area can also be the storage area of a setup trolley. It is conceivable, for example, that if an operator wishes to replace parts of the grinding machine, a replacement component is provided on the storage area of the setup trolley. The device then transports the replacement component from the storage area of the setup trolley to the grinding machine, where the replacement component can then be exchanged with a component to be replaced. The replaced component can then be transported by the device to the storage area of the setup trolley. This has the advantage that maintenance work on the grinding machine can be at least partially automated by the device.

Alternatively, the pick-up area and the delivery area can be spatially separated from each other. This means that the pick-up area and the delivery area preferably do not overlap. For example, the device for loading and unloading the grinding machine can be arranged at least in sections between the pick-up area and the delivery area.

The pick-up area and/or the delivery area can each be an area in which the device can be manually loaded or manually unloaded.

Irrespective of this, the pick-up area and/or the delivery area may be a storage space. Advantageously, several, in particular different, objects are provided in a storage space. For example, clamping devices, grinding wheels, cooling oil nozzles, dressing wheels and/or tailstock tips for the grinding machine can be provided in the storage space. Preferably, the device is designed to transport the objects selectively, i.e. individually, from the storage space to the grinding machine and/or from the grinding machine to the storage space.

In another exemplary embodiment of the device, a workpiece spindle is arranged on the carrier. The workpiece spindle is designed to rotate a workpiece arranged on the workpiece spindle. In an embodiment in which a workpiece spindle is arranged on the carrier, advantageously the workpiece spindle is pivoted about the first axis of rotation when the carrier rotates about the first axis of rotation. This has the advantage that the workpiece spindle can be made more easily accessible for improved maintainability or can be moved into a measuring position. Furthermore, the workpiece spindle can advantageously also be loaded manually if the workpiece spindle is made accessible to a user by rotating the carrier.

The workpiece spindle can be rotatable about a third axis of rotation, in particular rotate about a third axis of rotation. Preferably, the third axis of rotation is offset parallel to the first axis of rotation. Alternatively or additionally, the third axis of rotation can be arranged parallel to the second axis of rotation.

Advantageously, the swivel device is designed to transport a workpiece towards the workpiece spindle and away from the workpiece spindle.

For example, the swivel device can be pivotable about the second axis of rotation in such a way that the workpiece is transported to the workpiece spindle by the swivel movement of the swivel device about the second axis of rotation. Advantageously, this means that the workpiece can already be arranged on the workpiece spindle when the carrier is still rotating about the first axis of rotation in order to rotate the workpiece into the machining position. This has the advantage that the grinding machine can be loaded faster and more effectively by the device.

In addition, the swivel device can be pivotable about the second axis of rotation in such a way that the workpiece is transported away from the workpiece spindle by the swivel movement of the swivel device about the second axis of rotation. This advantageously means that the workpiece can already be moved away from the workpiece spindle when the carrier initially rotates out of the machining position. This has the advantage that the grinding machine can be unloaded more quickly and effectively by the device.

The swivel device can be movably arranged on the carrier. For example, the swivel device can be arranged on the carrier so that it can move axially in relation to the first axis of rotation and/or in relation to the second axis of rotation. A movable arrangement of the swivel device on the carrier advantageously means that an object can also be transported by the swivel device in an axial direction, for example. This has the advantage that the object can be raised and/or lowered by the device, in particular by the swivel device.

The gripping device can have two gripper arms. The gripper arms are preferably designed to be able to assume a gripping position and a release position relative to each other. In the release position, the gripper arms are arranged relative to each other in such a way that the gripper arms can release the object. In the gripping position, the gripper arms are arranged relative to each other in such a way that the gripper arms can grip the object together or jointly.

For the purposes of the present invention, the term “gripping” is understood to mean clamping, in particular jamming or clamping, of the object between the gripper arms. For example, the gripper arms can exert a clamping force on the object in the gripping position.

Alternatively or additionally, the term “gripping” can also include gripping underneath the object by the gripper arms. For example, the gripper arms can grip underneath the object in the gripping position. Preferably, the gripper arms are connected to the object in the gripping position in a force-fit and/or form-fit manner.

For the purposes of the present invention, the term “releasing” is understood to mean a release of the contact between the gripper arms and the object. For example, the contact between the gripper arms and the object can be released when the gripper arms change from the gripping position to the release position. An object is preferably already considered to be released when the object is only in contact with one gripper arm. The gripping device can have a drive setup to drive the gripper arms. For example, the drive setup can be a pneumatic drive. The drive setup can be designed so that the gripper arms can be driven together or separately by the drive setup. The gripping device can be pneumatic, hydraulic and/or electric, e.g. as an electric servo gripper. The gripper arms can be hydraulically actuated, especially for heavy objects.

The gripping device can have three or more gripper arms or gripper elements: Alternatively or in addition to the gripper arms, one or more rotary mandrels can also be provided on the gripping device. A jaw chuck is also conceivable as an alternative to the gripper arms. For example, a workpiece could be clamped to the gripping device by the jaw chuck via one or more holes in the workpiece.

In an exemplary further development, the swivel device can have a changing device instead of or in addition to the gripping device. The changing device can be designed to carry out the changing of components on the grinding machine automatically. This means that the components of the grinding machine can be replaced by the changing device without the intervention of an operator, or only with minimal operator involvement. For example, a clamping device and/or a grinding wheel of the grinding machine can be changed by the changing device.

Additionally or alternatively, the changing device can be designed to automatically mount an additional component on the grinding machine. For example, the changing device can be used to mount a workpiece spindle on the carrier.

Preferably, the gripping device and the changing device are a single device. In other words, the gripping device can be designed in such a way that the gripping device can also perform the functions of the changing device.

As an alternative or in addition to the gripping device, the swivel device can also have a pick-up/feed device. The pick-up/feed device can, for example, be an electromagnetic pick-up/feed device. In particular, the electromagnetic pick-up/feed device can be designed to attract and/or repel the object by generating an electromagnetic field. Independently of this, it is conceivable that the pick-up/feed device is a suction device. For example, the suction device can be designed to suck in the object by generating negative pressure and/or push it off by generating positive pressure.

The carrier or the swivel device can have a steady rest or a support for shaft parts.

Preferably, the pick-up/feed device and the changing device are a single device. In other words, the pick-up/feed device can be designed in such a way that the pick-up/feed device can also perform the functionalities of the changing device.

In order to reduce oil carryover, the device can have a blow off device. The blow off device is advantageously designed to remove lubricant and/or coolant residues, in particular oil residues, from the workpieces. In addition or alternatively, the blow off device can be designed to free the device from lubricant and/or coolant residues, in particular oil carryover, or at least to reduce these.

In another exemplary embodiment, the carrier can have a carrier tower. The carrier tower is preferably arranged vertically on the carrier. For example, the carrier tower may be a tower-shaped body arranged vertically on the carrier. The carrier tower can be cylindrical, at least in sections. Irrespective of this, the carrier tower can be provided eccentrically on the carrier in relation to the first axis of rotation.

In a further development of the aforementioned embodiments, the holder can be arranged movably on the carrier tower. Preferably, the holder is provided on the carrier tower so as to be axially movable with respect to the first axis of rotation. Such a constructive design advantageously means that the holder, and thus preferably also the swivel device arranged on the holder, is easily accessible to a user. This has the advantage that the maintainability of the device is increased.

At the same time, such an arrangement has the effect that the second axis of rotation is provided outside the carrier tower, in particular outside the outer dimensions of the carrier tower. This has the advantage that the swivel range of the swivel device is increased.

A dressing device can be provided on the carrier. The dressing device can be designed for dressing an abrasive of the grinding machine. Preferably, the dressing device is arranged radially offset on the carrier in relation to the first axis of rotation. This has the effect that when the carrier rotates about the first axis of rotation, for example, the dressing device is swivelled about the first axis of rotation. This has the advantage that the dressing device can be positioned relative to the abrasive by rotating the carrier about the first axis of rotation in such a way that the abrasive can be dressed by the dressing device.

The dressing device can be moved vertically and/or horizontally in relation to the carrier. Alternatively or additionally, the dressing device can be pivotable in relation to the carrier.

For this purpose, the carrier can, for example, assume a dressing position. In the dressing position, the grinding machine can preferably be maintained in such a way that the abrasive is dressed or reground by the dressing device. Independently of this, the device in the dressing position can advantageously also be maintained and/or manually loaded by a user. The device, in particular the swivel device of the device, can be more easily accessible to a user in the dressing position.

In an exemplary further development, the carrier tower can be provided at least in sections between the workpiece spindle and the dressing device. Preferably, the carrier tower is arranged on the carrier in such a way that it spatially separates the workpiece spindle and the dressing device. Alternatively or additionally, the dressing device can be arranged at least partially in the carrier tower. The spatial separation of the dressing device from the workpiece spindle by the carrier tower advantageously means that the workpiece spindle is protected by the carrier tower from possible chips that may be produced as a waste product during dressing. Conversely, the dressing device can be protected by the carrier tower from possible chips that are produced as a waste product during the grinding of the workpiece. This has the advantage of increasing the durability of the device, in particular the components on the carrier.

To protect the dressing device and/or the workpiece spindle, the carrier tower can, for example, have a first outer wall that faces the workpiece spindle. A second outer wall of the carrier tower can face the dressing device. The second outer wall is preferably a side wall of the carrier tower opposite the first outer wall. The workpiece spindle and/or the dressing device are advantageously shielded by the respective outer wall of the carrier tower in such a way that the workpiece spindle and/or the dressing device are largely protected from contamination emanating from the working chamber. This has the advantage that the durability of the device, in particular the components on the carrier, is increased.

In another exemplary embodiment, the device comprises a centering device. The centering device can be designed to align, in particular to center, the workpiece in relation to another component of the device and/or in relation to a component of the grinding machine. For example, the centering device can be provided for aligning, in particular centering, a workpiece in relation to the workpiece spindle. The centering device can additionally or alternatively be designed to support the workpiece. For example, the centering device can support the workpiece when the workpiece is driven by the workpiece spindle. The centering device is preferably a tailstock. The embodiment with centering device has the advantage that the grinding machine can be loaded very precisely by the device and/or the workpiece can be held in position during grinding. This increases the accuracy of the grinding machine in particular. Advantageously, manufacturing tolerances on the workpiece can be minimized.

In a device according to the present invention, the carrier can be dimensioned larger, in particular have a larger cross-section. This means that the centering apparatus can also be dimensioned larger and/or is more stable together with the carrier. Advantageously, this increases the accuracy of the grinding machine. This has the advantage that the workpiece quality increases.

The device can have a position-determining device. The position-determining device is preferably designed to detect the position of the workpiece, in particular at least one tooth space of the workpiece. For example, the position-determining device detects the position of the workpiece after the grinding device has been loaded with the workpiece.

Alternatively or additionally, the position-determining device detects the position of the workpiece after the workpiece has been placed on the workpiece spindle by the gripping device. In particular, the position determining device can be designed to determine the position of tooth flanks or tooth spaces of the workpiece. It is also conceivable that the position determination device can be used to determine the angle of rotation of the workpiece. Alternatively or additionally, the position-determining device can be designed to determine the position of the gripping device and/or the pick-up/feed device.

To determine the respective position, the position-determining device can have at least one sensor. The sensor can be an optical and/or an electromagnetic sensor, in particular a distance sensor. The sensor can be an inductive sensor, for example. The detection of the position of the workpiece by the position-determining device has the advantage that the accuracy of the grinding machine is increased. For example, an abrasive of the grinding machine can be better aligned with the workpiece depending on the determined position of the workpiece, which minimizes the manufacturing tolerances on the workpiece. In particular, the position of the workpiece can be determined by the position-determining device in such a way that it is ensured that the abrasive does not collide with a tooth of the workpiece when it is brought into contact.

In an exemplary further development of the embodiment with a position-determining device, the position-determining device is arranged on the carrier, in particular arranged on the carrier tower. For example, the position-determining device can be arranged movably on the carrier, in particular arranged movably on the carrier tower. The position-determining device can be arranged on the carrier so as to be axially movable with respect to the first axis of rotation and/or with respect to the second axis of rotation, in particular so as to be axially movable on the carrier tower. The arrangement of the position-determining device on the carrier has the advantage that the measuring accuracy of the position-determining device can be increased.

The carrier can be mounted hydrostatically on the base. In particular, a hydrostatic bearing can improve the rotatability of the carrier about the first axis of rotation. This has the advantage that the carrier remains rotatable, in particular smoothly rotatable, in relation to the first axis of rotation even with heavy loads, in particular with heavy objects which, for example, have a dead weight of >100 kg. In addition, a hydrostatic bearing enables high rigidity of the connection between carrier and base and precise positioning. The damping properties can also be improved by the hydrostatic bearing.

Alternatively or additionally, the carrier can also be connected to the base by means of an ordinary bearing. For example, the carrier can be mounted on the base via an ordinary rolling and/or plain bearing.

In another exemplary embodiment, the device comprises a control system. The control system may be a computer and/or a programmable logic unit (CPU). The control system can be integrated in the device.

The control system is preferably designed to control the rotational movement of the carrier, the swivel movement of the swivel device, the dressing device, the workpiece spindle, the centering device, the gripping device, the changing device, and/or the pick-up/feed device.

The control system can also be designed to control the rotational movement of the carrier, the swivel movement of the swivel device, the dressing device, the workpiece spindle, the centering device, the gripping device, the changing device and/or the pick-up/feed device. This is particularly the case if the control system is connected to one or more control sensors in an information-communicating manner. The control can then be carried out on the basis of a target/actual comparison with the information from the control sensor.

The control sensor is preferably at least one sensor that is designed to monitor the rotational movement of the carrier, the swivel movement of the swivel device, the dressing device, the workpiece spindle, the centering device, the gripping device, the changing device and/or the pick-up/feed device. The term “monitor” in the present sense is understood to mean the determination of a position, a speed and/or an acceleration of one of the aforementioned components. The term “monitoring” also includes determining other physical variables, such as temperature and/or pressure.

Additionally or alternatively, the control system can be connected to the position-determining device for information communication. Independently of this, the control system can be designed to recognize which optional devices are provided on the device. For example, the control system recognizes whether a gripping device, a changing device and/or a pick-up/feed device is provided on the swivel device. Preferably, the control system is designed to adapt at least the control system and/or regulation of the rotational movement of the carrier and/or the swivel movement of the swivel device depending on the recognized optional devices. The control system has the advantage that the transport of the object to the grinding machine and/or away from the grinding machine can be automated, or at least partially automated. For example, the control system can be used to automate the loading of the grinding machine with a workpiece. The replacement of a component with a replacement component and/or the assembly of an accessory component can also be automated, or at least partially automated, using a control system.

In an exemplary further development of the embodiment, in which the device comprises a control system, the device has an input means. The input means can be designed to receive control inputs from an operator and transmit them to the control system. The input means may, for example, be a joystick that can be operated by an operator.

In another exemplary embodiment, the device comprises an additional transport device. In particular, the additional transport device may be a robot and/or a robot arm. The additional transport device can be designed to interact with the gripping device, the changing device and/or the pick-up/feed device. It can be designed as an additional element of a setup trolley. For example, it is conceivable that the object to be transported can be transferred or exchanged between the transport device and the gripping device.

The additional transport device has the advantage that the effective range of the device, in particular the transport radius of the device, is increased.

The task mentioned at the beginning is also solved according to the invention by a grinding machine for gear grinding of a workpiece, in particular a pre-toothed workpiece, such as a gear blank. For this purpose, the grinding machine comprises a machine housing, a grinding device and a device as described above. According to the invention, the grinding device is arranged on the machine housing and is designed for grinding the workpiece. The machine housing of the grinding machine forms the base of the device according to the above embodiments.

The advantage of the grinding machine according to the invention is that the grinding machine can be loaded and unloaded with workpieces more quickly by means of the device. In addition or independently thereof, the carrier, which is rotatable about the first axis of rotation, has the effect of increasing the accessibility to the individual components of the grinding machine. This has the advantage that the grinding machine according to the invention is easier to maintain. The carrier can also be designed to be more stable compared to other loading concepts, in particular with regard to the centering apparatus.

In a first exemplary embodiment, the grinding machine comprises a dressing device arranged on the carrier and a workpiece spindle arranged on the carrier. The dressing device can be designed for dressing, in particular for profiling and/or resharpening, the abrasive of the grinding machine. Preferably, the dressing device is arranged radially offset on the carrier in relation to the first axis of rotation. This has the effect, for example, that when the carrier rotates about the first axis of rotation, the dressing device is pivoted about the first axis of rotation.

The workpiece spindle is preferably designed to rotate a workpiece arranged on the workpiece spindle. The workpiece spindle can be rotatable about a third axis of rotation, in particular rotate about a third axis of rotation. Preferably, the third axis of rotation is offset parallel to the first axis of rotation. The workpiece spindle can be arranged eccentrically on the carrier in relation to the first axis of rotation. This has the effect that when the carrier rotates about the first axis of rotation, for example, the workpiece spindle is pivoted about the first axis of rotation.

The carrier can be rotatable about the first axis of rotation in such a way that the carrier can be rotated back and forth between a grinding position and a dressing position.

Preferably, the workpiece spindle faces the grinding device in the grinding position. This advantageously means that a workpiece can be machined on the workpiece spindle by the grinding device in the grinding position.

In the dressing position, the dressing device can face the grinding device. This advantageously means that an abrasive of the grinding device can be maintained by the dressing device in the dressing position. The dressing position can correspond to the aforementioned maintenance position of the device.

The grinding machine according to the first embodiment example has the advantage that the grinding machine is easy to handle and easy to maintain for a user.

The task mentioned at the beginning is also solved according to the invention by a Method with a device according to the above embodiments. In the method according to the invention, the rotational movement and the swivel movement are carried out simultaneously, at least temporarily, during a loading operation and/or during an unloading operation.

Advantageously, this causes the rotational movement and the swivel movement to be superimposed in such a way that the swivel device, in particular a gripper and/or pick-up/feed device arranged on the swivel device, undergoes a resulting transport movement. The transport movement can correspond to a linear movement. This has the advantage that the object for loading and unloading a grinding machine can be transported, at least temporarily, along a rectilinear path.

In a first exemplary embodiment of the Method, the carrier is rotated in a first direction of rotation about the first axis of rotation. The swivel device can be swiveled in a second direction of rotation about the second axis of rotation. Preferably, the first direction of rotation and the second direction of rotation are opposite directions of rotation. For example, the carrier can rotate clockwise about the first axis of rotation, while the swivel device swivels counterclockwise about the second axis of rotation. In other words, the carrier and the swivel device can have different directions of rotation when the rotational movement and the swivel movement are superimposed.

Advantageously, this causes the rotational movement and the swivel movement to be superimposed in such a way that the swivel device, in particular a gripper and/or pick-up/feed device arranged on the swivel device, undergoes a resulting transport movement. The transport movement can correspond to a linear movement. This has the advantage that the object for loading and unloading a grinding machine can be transported, at least temporarily, along a rectilinear path.

In a further embodiment of the aforementioned embodiment, the absolute angular amount of rotation of the rotational movement of the carrier about the first axis of rotation during the loading operation is smaller than the absolute angular amount of rotation of the swivel movement of the swivel device about the second axis of rotation.

Alternatively or additionally, the absolute angular amount of rotation of the rotational movement of the carrier about the first axis of rotation during the unloading operation can be smaller than the absolute angular amount of rotation of the swivel movement of the swivel device about the second axis of rotation.

This has the advantage that the device is easier to control or regulate.

The task mentioned at the beginning is also solved according to the invention by using a device according to the above embodiments for loading and unloading a grinding machine, wherein the object is a workpiece. Preferably, the grinding machine is a gear grinding machine.

The task mentioned at the beginning is also solved according to the invention by the use of a device according to the above embodiments for the maintenance of a grinding machine, wherein the object is a replacement component and/or an accessory component for the grinding machine. Preferably, the grinding machine is a gear grinding machine.

In order to be able to perform different handling functions, in particular transport, holding and/or positioning functions of different objects, the swivel device is advantageously designed such that different grippers, holders and devices can be attached thereto in order to be able to grasp different objects. In particular, the swivel device comprises a corresponding interface for this purpose. The control system advantageously recognizes the respective gripper, holder or device and only allows the corresponding movements. The degrees of freedom of the swivel arm can be used for the additional handling functions and in particular also for replacing the grippers, holders or devices. The grippers, holders or other devices can also be kept ready in a storage space or on a setup trolley.

It is also possible for the gripper intended for the workpiece change to remain in the machine during the other handling functions and for further elements to be attached for the latter, or for the gripper itself to grip the corresponding elements. Here too, the control system approves the permitted movement sequences depending on the operation to be performed.

### BRIEF DESCRIPTION OF THE DRAWINGS

The different and exemplary features described above can be combined with each other according to the invention, insofar as this is technically sensible and suitable. Further features, advantages and embodiments of the invention are shown in the following description of examples of embodiments and with reference to the figures. The figures show:

FIG. 1 a perspective view of a grinding machine with an embodiment of a device for loading and unloading the grinding machine;

FIG. 2 a further perspective view of the embodiment according to FIG. 1 from a different angle;

FIG. 3 a top view of the embodiment according to FIG. 1 at the beginning of a loading operation;

FIG. 4 a top view of the embodiment according to FIG. 1 during a transport operation as part of the loading operation;

FIG. 5 a top view of the embodiment according to FIG. 1 at the end of the loading operation and/or at the beginning of the unloading operation;

FIG. 6 a top view of the embodiment according to FIG. 1 during a transport operation as part of the unloading operation;

FIG. 7 a top view of the embodiment according to FIG. 1 at the end of the unloading operation;

FIG. 8 a side view of the embodiment according to FIG. 1, in which the grinding machine is in a dressing position; and

FIG. 9 eine Seitenansicht des Ausführungsbeispiels gemäss FIG. 1, bei der sich die Schleifmaschine in einer Schleifposition befindet.

### WAYS TO IMPLEMENT THE INVENTION

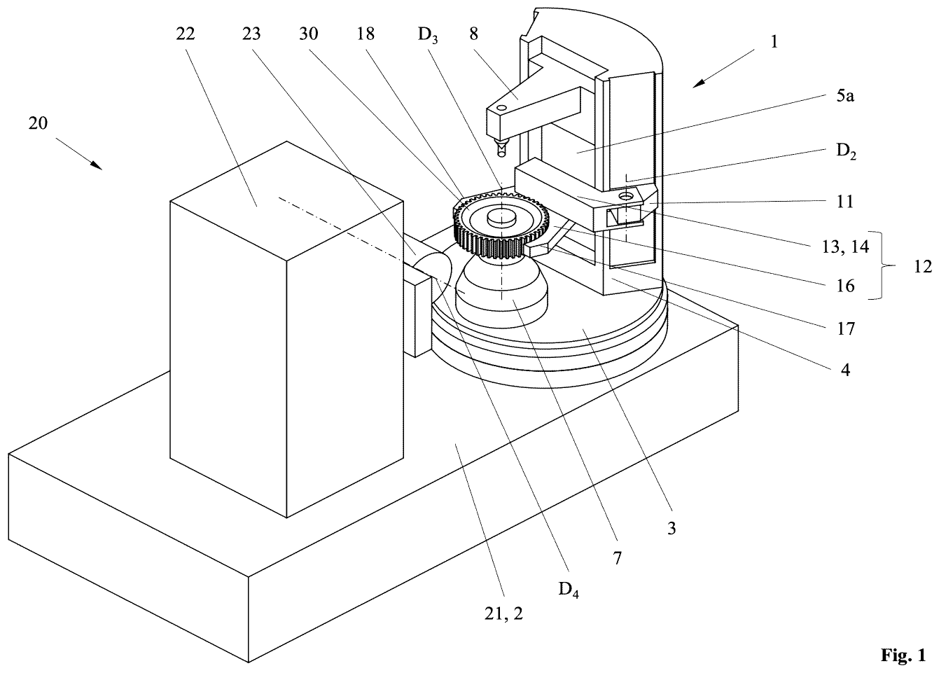

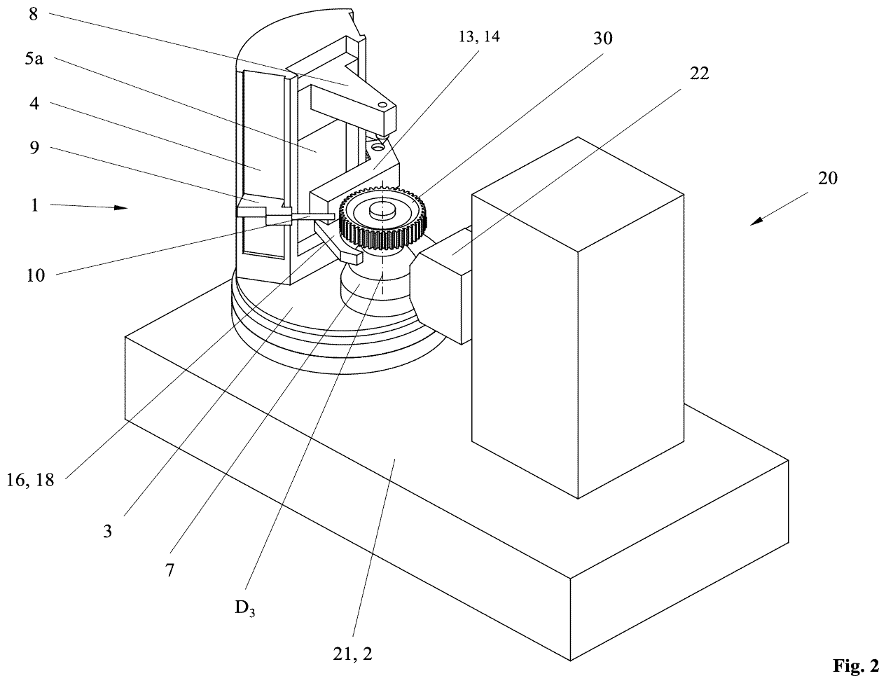

FIG. 1 shows an embodiment of a grinding machine 20 with a device 1. The device 1 is designed to load and unload the grinding machine 20 with a workpiece 30. FIG. 2 shows the embodiment of the grinding machine 20 in a further perspective view, wherein a different viewing angle was selected in FIG. 2 than in FIG. 1.

The grinding machine 20 comprises a machine housing 21 and a grinding device 22. The grinding device 22 has an abrasive 23. The abrasive 23 is designed to grind the workpiece 30. In particular, the abrasive 23 is a grinding worm 23.

The device 1 comprises a base 2, a carrier 3 and a swivel device 12. In the embodiment shown, the base 2 corresponds to the machine housing 21.

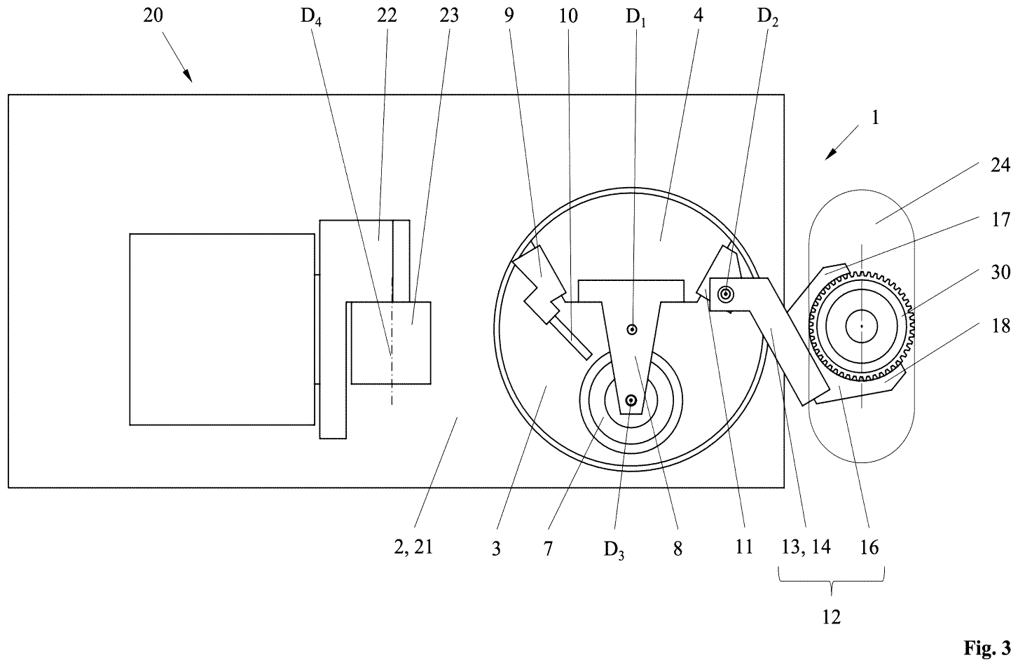

The carrier 3 is rotatable in relation to the base 2 about a first axis of rotation D₁ not shown in FIG. 1 (see FIGS. 3-9). The carrier 3 has a carrier tower 4 and a workpiece spindle 7. The workpiece spindle 7 faces a first outer wall 5a of the carrier tower 4. The carrier tower 4 and the workpiece spindle 7 are rotatable together with the carrier 3 about the first axis of rotation D₁.

A centering device 8 is arranged on the carrier tower 4. This is designed to center the workpiece 30 on the workpiece spindle 7. In the embodiment shown, the centering device 8 is a tailstock 8. A holder 11 is also arranged on the carrier tower 8. This can be moved vertically along the carrier tower 4. A swivel device 12 is connected to the holder 11.

The swivel device 12 is connected to the holder 11 in such a way that the swivel device 12 is pivotable about a second axis of rotation D₂. The second axis of rotation D₂ is spaced from the carrier tower 4 by the holder 11 in such a way that the second axis of rotation D₂ is provided outside the dimensions of the carrier tower 4.

The swivel device 12 comprises a swivel means 13, which in the embodiment is designed as a swivel arm 14. Furthermore, the swivel device 12 has a gripping device 16. The swivel arm 14 is designed to distance the gripping device 16 from the second axis of rotation D₂ in the radial direction.

The gripping device 16 comprises a first gripper arm 17 and a second gripper arm 18. The gripper arms 17, 18 are designed to be able to assume a gripping position and a release position relative to one another. In the release position, the first gripper arm 17 and the second gripper arm 18 are arranged relative to each other in such a way that the gripper arms 17, 18 can release the workpiece 30. In the gripping position shown in FIG. 1, the first gripper arm 17 and the second gripper arm 18 are arranged relative to each other in such a way that the gripper arms 17, 18 grip the workpiece 30. In doing so, the gripper arms 17, 18 together exert a clamping force on the workpiece 30 so that the workpiece 30 is immovably connected to the gripping device 16.

The workpiece 30 can now be lifted from the position shown in FIG. 1, for example, by moving the holder 11 with the gripping device 16 vertically upwards on the carrier tower 4.

The workpiece spindle 7 is rotatable in relation to the carrier 3 about a third axis of rotation D₃, in particular for rotating a workpiece 40 arranged on the workpiece spindle 7, whereby the first gripper arm 17 and the second gripper arm 18 are in a release position relative to each other.

To grind the workpiece 30, the grinding device 22 is displaced with respect to the device 1 in such a way that the abrasive 23 contacts the workpiece 30. The abrasive 23 rotates about a fourth axis of rotation D₄. At the same time, the workpiece 30 is rotated about the third axis of rotation D₃. The fourth axis of rotation D₄ is arranged orthogonally with respect to the third axis of rotation D₃. To drive the abrasive 23, the grinding device 22 has a drive setup (not shown).

With regard to the functionality of the device 1 during loading and unloading of the grinding machine 20, reference is made to FIGS. 3-7, as well as to the respective associated figure descriptions.

In the embodiment, the device 1 comprises a position-determining device 9 (see FIG. 2). The position-determining device 9 is arranged on the carrier tower 4 and is movable in relation to the carrier tower 4. In particular, the position-determining device 9 is movable in a vertical direction with respect to the carrier tower 4.

The position-determining device 9 comprises at least one sensor 10, which faces the workpiece spindle 7 and, in particular, the workpiece 30 on the workpiece spindle 7. In the embodiment shown, the position-determining device 9 comprises a single sensor 10. The sensor 10 can be an optical, tactile or non-contact sensor. Preferably, the sensor 10 is an inductive sensor 10. The sensor 10 is designed to determine the position of the workpiece 30, in particular the rotational angle position of the workpiece 30. The position-determining can thus be carried out on the basis of the tooth flanks of the workpiece 30 rotating past the sensor 10.

FIG. 3 shows a top view of the grinding machine 20 of the embodiment. As can be seen in FIG. 3, the first axis of rotation D1, the second axis of rotation D₂ and the third axis of rotation D₃ are spaced parallel to each other. As a result, for example, when the carrier 3 rotates about the first axis of rotation D1, the second axis of rotation D₂ is moved on a circular path around the first axis of rotation D1. With regard to the further structure of the grinding machine 20, reference is made to the above explanations.

The device 1 is in a position which it can assume at the beginning of a loading operation. This can be recognized by the fact that a workpiece 30 has been provided within a pick-up area 24. In the situation shown in FIG. 3, the workpiece 30 has been provided centrally in the pick-up area 24. However, it is also conceivable that the workpiece 30 is provided decentrally in the pick-up area 24. This means that the device 1 is capable of gripping the workpiece 30 whenever the workpiece 30 is provided at any location within the pick-up area 24. The pick-up position of the workpiece 30 may vary in the radial and/or axial direction within the boundaries of the pick-up area 24.

In order to move from the position of the device 1 shown in FIG. 1 and FIG. 2 to the position of the device 1 shown in FIG. 3, the carrier 3 was rotated counterclockwise about the first axis of rotation D1. The swivel device 12 was also swiveled counterclockwise about the second axis of rotation D₂. The rotational movement of the carrier 3 and the swivel movement of the swivel device 12 were carried out simultaneously, at least at times, in such a way that the gripping device 16 could grasp the workpiece 30 with the gripper arms 17, 18 on both sides. In order to grip the workpiece 30, the first gripper arm 17 and the second gripper arm 18 assumed the gripping position.

In order to optionally lift the workpiece 30, the holder 11 can be moved, in particular lifted, along the carrier tower 4, in particular parallel to the first axis of rotation D1.

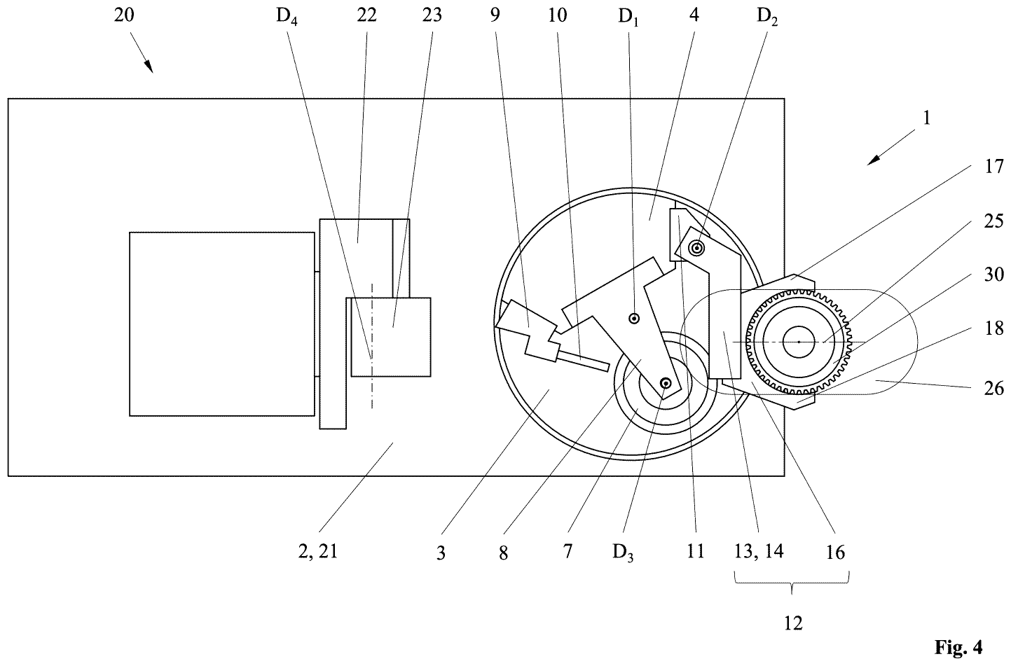

FIG. 4 shows the device 1 during a transport operation as part of the loading of the grinding machine 20.

FIG. 3 shows a top view of the grinding machine 20 of the embodiment. As can be seen in FIG. 3, the first axis of rotation D1, the second axis of rotation D₂ and the third axis of rotation D₃ are spaced parallel to each other. As a result, for example, when the carrier 3 rotates around the first axis of rotation D1, the second axis of rotation D₂ is moved on a circular path around the first axis of rotation D1. With regard to the further structure of the grinding machine 20, reference is made to the above explanations.

In order to move from the position of the device 1 shown in FIG. 3 to the position of the device 1 shown in FIG. 4, the carrier 3 is rotated counterclockwise about the first axis of rotation D1. The swivel device 12 is swiveled clockwise about the second axis of rotation D₂. The rotational movement of the carrier 3 and the swivel movement of the swivel device 12 are carried out simultaneously, at least at times, in such a way that the workpiece 30 is transported on a rectilinear path 25 and thus undergoes a rectilinear transport movement. The rectilinear transport path 25 shown in FIG. 4 as a dotted line indicates the course of movement of the workpiece 30, in particular the path movement of the center of the workpiece 30, during the rectilinear transport movement as part of the loading operation. The elliptical area 26 shown in FIG. 4 represents the limits of the movement range 26 in which the workpiece 30 moves during the rectilinear transport movement.

The transport movement on the rectilinear path 25 results from the superimposition of the rotational movement of the carrier 3 with the swivel movement of the swivel device 12. The workpiece 30 follows the resulting transport movement of the swivel device 12 because the gripping device 16 has gripped the workpiece 30 during the transport operation and the workpiece 30 is accordingly immovably connected to the gripping device 16.

At the end of the transport movement, during which the workpiece 30 is moved along the rectilinear path 25, the workpiece 30 is preferably located above or on the workpiece spindle 7.

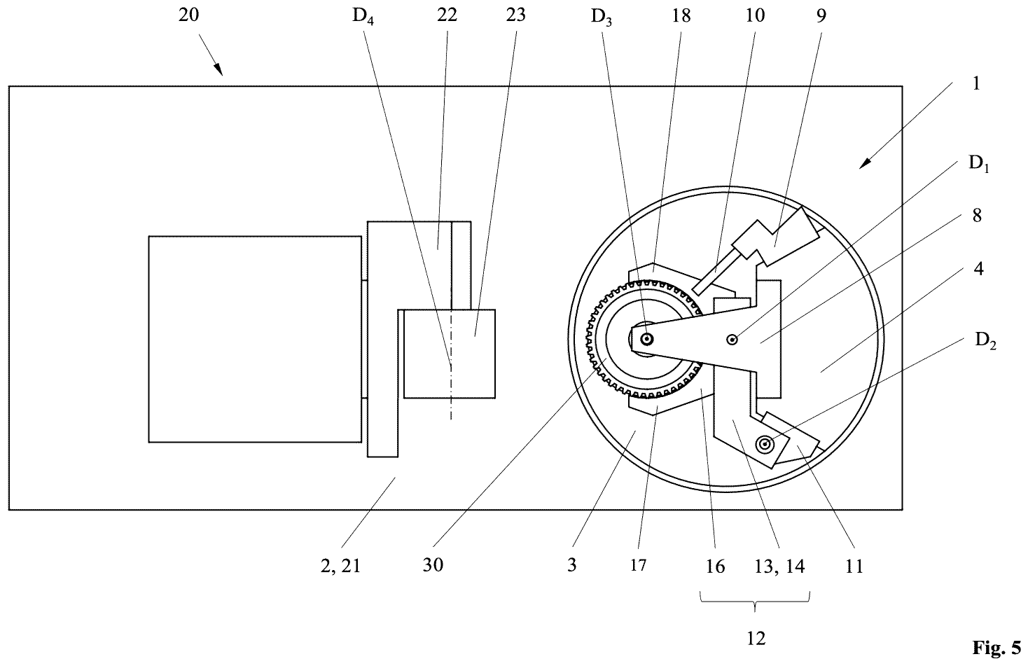

Subsequently, the carrier 3 can be rotated clockwise or counterclockwise about the first axis of rotation D₁ such that the device 1 assumes the position shown in FIG. 5.

The sequence shown enables the workpiece 30 to be transported with very little space requirement in the vicinity of the device 1. If the space conditions permit, the rotation of the carrier 3 into the machining position according to FIG. 5 can already begin before the workpiece 30 has assumed its position in relation to the workpiece spindle 7. This enables faster loading. In general, the path movement of the workpiece 30 can be varied within wide limits during the transport operation by adjusting the rotation and swivel movement sequences.

FIG. 5 shows the device 1 at the end of the loading operation and/or at the beginning of the unloading operation.

This can be recognized by the fact that the workpiece 30 is arranged on the workpiece spindle 7, which is covered by the workpiece 30. The workpiece spindle 7 faces the grinding device 22. The first gripper arm 17 and the second gripper arm 18 are in a gripping position relative to each other and exert a clamping force on the workpiece 30.

At the end of a loading operation, the gripper arms 17, 18 would now change from the gripping position to a release position. As a result, the workpiece 30 is released by the gripping device 16. The workpiece 30 can be fed onto the workpiece spindle 7. As soon as the workpiece spindle 7 rotates about the third axis of rotation D₃, the workpiece 30 can be driven to rotate by the rotation of the workpiece spindle 7.

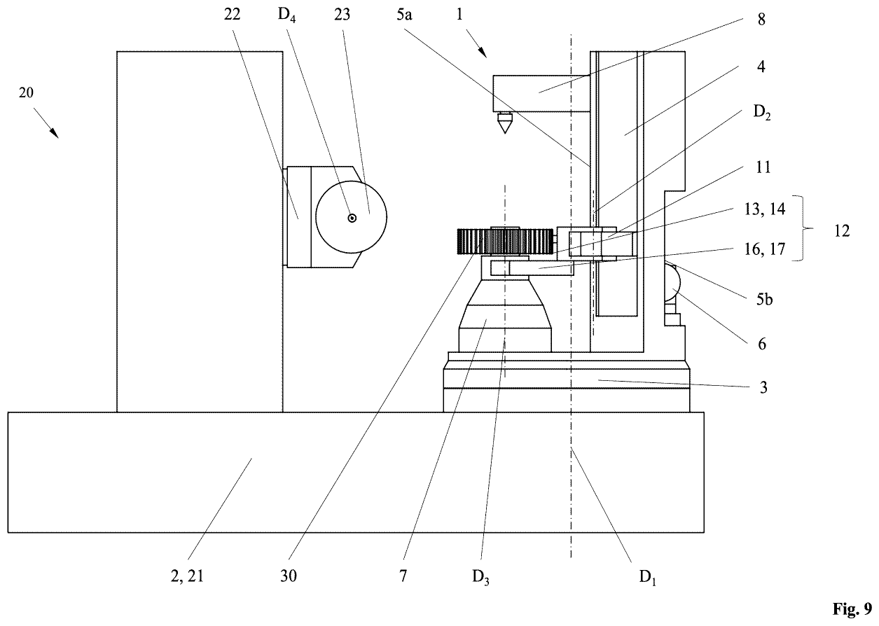

As soon as the workpiece 30 rotates, the workpiece 30 can be ground by the abrasive 23. For this purpose, the grinding device 22 is moved in the direction of the workpiece 30, starting from the position shown in FIG. 5. With regard to the specific sequence of the grinding operation, which is preferably carried out between the loading operation and the unloading operation, reference is made to the figure description of FIG. 9.

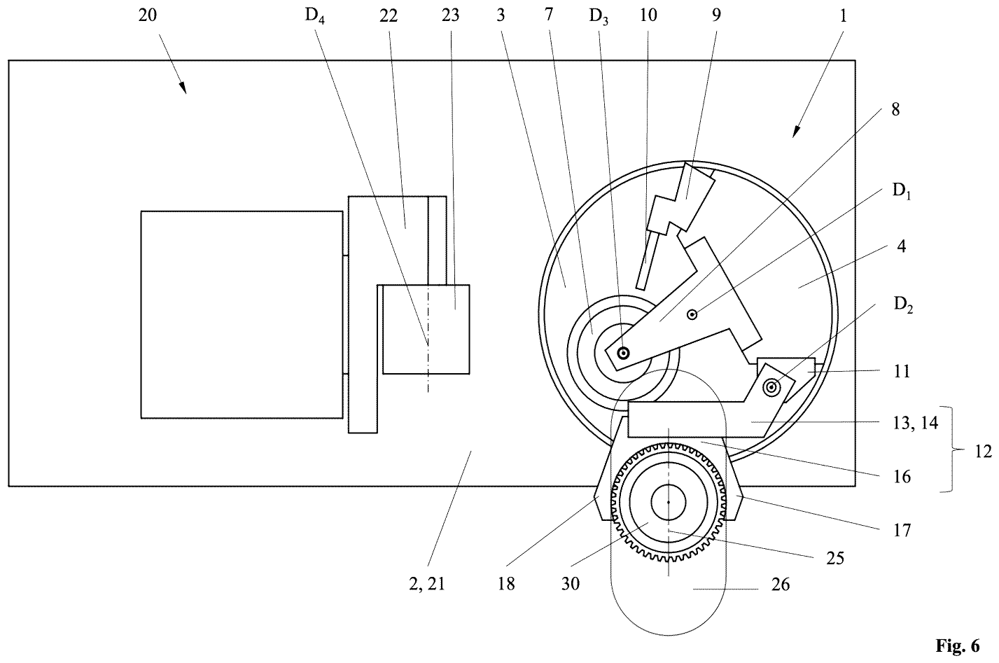

For unloading the grinding machine 20, the workpiece 30 processed by the abrasive 23 is transported away from the device 1. Part of this transport movement during the unloading operation is shown schematically in FIG. 6.

In order to move from the position of the device 1 shown in FIG. 5 to the position of the device 1 shown in FIG. 6, the carrier 3 was rotated counterclockwise by 90° about the first axis of rotation D₁.

Subsequently, the carrier 3 is rotated clockwise about the first axis of rotation D₁, wherein the swivel device 12 is simultaneously swiveled counterclockwise about the second axis of rotation D₂. As a result, the workpiece 30 is transported on a rectilinear path 25 and thus undergoes a rectilinear transport movement. The rectilinear transport path 25 shown in FIG. 6 as a dotted line represents the course of movement of the workpiece 30, in particular the path movement of the center of the workpiece 30, during the rectilinear transport movement as part of the unloading operation. The elliptical area 26 shown in FIG. 6 represents the limits of the movement range 26 in which the workpiece 30 moves during the rectilinear transport movement.

The transport movement on the rectilinear path 25 results from the superimposition of the rotational movement of the carrier 3 with the swivel movement of the swivel device 12. The workpiece 30 held by the gripping device 16 follows the resulting transport movement of the swivel device 12.

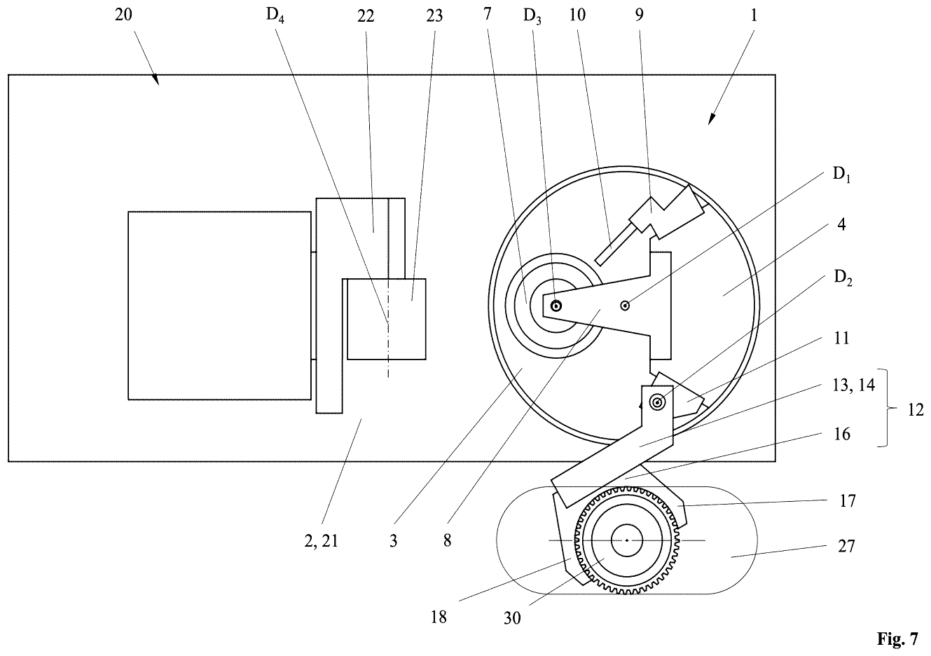

At the end of the rectilinear transport movement shown in FIG. 6, the workpiece 30 is delivered to a delivery area 27, as shown in FIG. 7.

The device 1 is designed to deliver the workpiece somewhere within the delivery area 27. As an alternative to the central delivery position shown in FIG. 7, the device 1 can therefore also deliver the workpiece 30 in the left-hand part and/or in the right-hand part of the delivery area 27. Starting from the position of the gripping device 16 shown in FIG. 7, only the first gripper arm 17 and the second gripper arm 18 need to be moved relative to each other in such a way that the gripper arms 17, 18 assume a release position and release the workpiece 30.

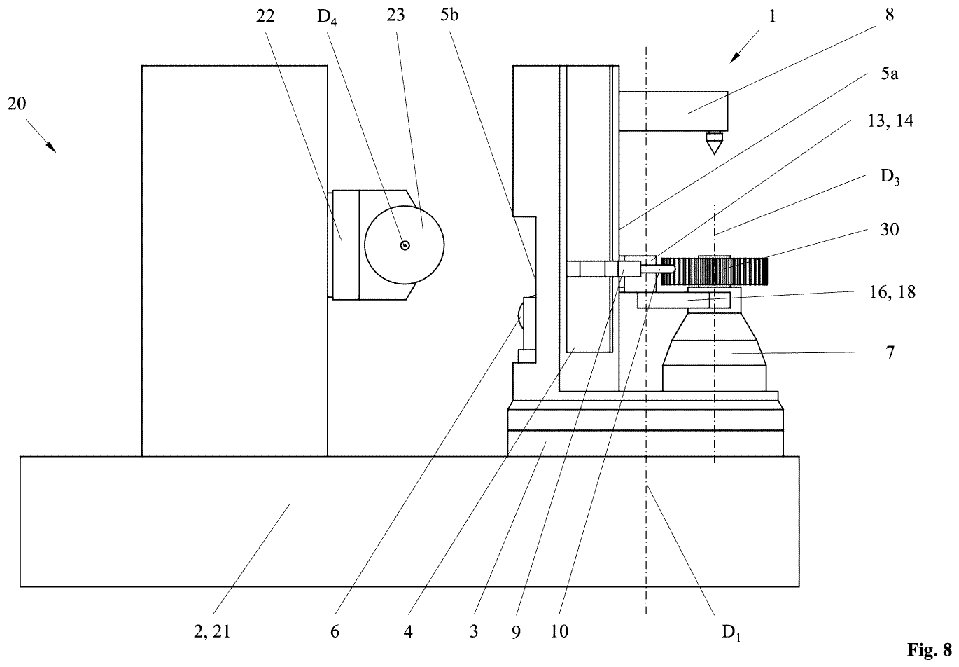

FIG. 8 shows a side view of the embodiment of the grinding machine 20, wherein the grinding machine 20, in particular the device 1 of the grinding machine 20, is in a dressing position.

The device 1 has a dressing device 6. The dressing device 6 is designed for dressing, in particular for profiling and/or resharpening, the abrasive 23 of the grinding machine 20. For this purpose, the dressing device 6 faces the abrasive 23 in the dressing position.

The dressing device 6 is arranged on the carrier 3 in such a way that it is at least partially integrated in the carrier tower 4. The carrier tower 4 is arranged between the workpiece spindle 7 and the dressing device 6. As shown in FIG. 8, the first outer wall 5a of the carrier tower 4 faces the workpiece spindle 7. A second outer wall 5b of the carrier tower 4 faces the dressing device 6. The arrangement of the dressing device 6, the carrier tower 4 and the workpiece spindle 7 on the carrier 3 has the advantage that the workpiece spindle 7 is not soiled during dressing of the abrasive 23 by the dressing device 6.

In order to dress the abrasive 23, the grinding machine 20 is designed to move the grinding device 22 in the direction of the dressing device 6 in such a way that the abrasive 23 and the dressing device 6 can interact with each other. In addition, a drive setup of the grinding device 22, which is not shown, can drive the abrasive 23 in such a way that the abrasive 23 rotates about the fourth axis of rotation D₄. If the rotating abrasive 23 contacts the dressing device 6, the abrasive 23 is dressed, in particular profiled and/or sharpened, by the dressing device 6.

As soon as the dressing of the abrasive 23 is complete, the grinding device 22 is moved away from the dressing device 6 until the initial dressing position shown in FIG. 8 is reached.

FIG. 9 shows a side view of the embodiment of the grinding machine 20, wherein the grinding machine 20 is in a grinding position.

This can be recognized by the fact that the workpiece spindle 7 and the workpiece 30 are facing the grinding device 22. The gripper arms 17, 18 of the gripping device 16 have assumed a release position relative to each other and are vertically spaced from the workpiece 30. This allows the workpiece spindle 7 and the workpiece 30 to rotate about the third axis of rotation D₃.

The arrangement of the dressing device 6, the carrier tower 4 and the workpiece spindle 7 in the grinding position means that the dressing device 6 is not or only very slightly soiled during the grinding operation.

In order to grind the workpiece 30, the drive setup of the grinding device 22, which is not shown, can drive the abrasive 23 in such a way that the abrasive 23 rotates about the fourth axis of rotation D₄. Independently of this, the grinding device 22 is moved in the direction of the workpiece spindle 7 in such a way that the abrasive 23 and the workpiece 30 come into engagement with each other, preferably in a rotating manner. If the abrasive 23 contacts the workpiece 30, the workpiece 30 is ground by the abrasive 23.

As soon as the grinding operation is complete, the grinding device 22 is moved away from the workpiece spindle 7 so that the grinding machine 20 returns to the initial grinding position shown in FIG. 9. Subsequently, the gripper arms 17, 18 of the gripping device 16 can change back to the gripping position. This allows the device 1 to assume the position shown in FIG. 5.

1. A device for transporting an object towards or away from a grinding machine, the device comprising:
(a) a base;
(b) a carrier arranged on the base, wherein the carrier is rotatable with respect to the base about a first axis of rotation (D₁),
(c) a swivel device arranged on the carrier for transporting the object, wherein
(d) the swivel device is pivotable with respect to the carrier about a second axis of rotation (D₂),
wherein the swivel device has a swivel means and a gripping device for gripping and releasing the object, wherein the swivel means spaces the gripping device from the second axis of rotation (D₂) in the radial direction,
wherein the swivel means is a swivel arm pivotably connected to a holder arranged on the carrier about the second axis of rotation (D₂), and
(e) the device is configured to carry out a rotational movement of the carrier about the first axis of rotation (D₁) and a swivel movement of the swivel device about the second axis of rotation (D₂) at least at times simultaneously in such a way that the object can be transported by a transport movement of the swivel device resulting from the superimposition of the rotational movement of the carrier with the swivel movement of the swivel device.

2. The device according to claim 1, wherein the first axis of rotation (D₁) and the second axis of rotation (D₂) are arranged relative to each other in such a way that the second axis of rotation (D₂) is moved on a circular path around the first axis of rotation (D₁) when the carrier rotates around the first axis of rotation (D₁).

3. The device according to claim 1, wherein the second axis of rotation (D₂) is displaced in parallel with respect to the first axis of rotation (D₁).

4. The device according to claim 1, wherein the device is configured to superimpose the rotational movement of the carrier about the first axis of rotation (D₁) and the swivel movement of the swivel device about the second axis of rotation (D₂) in such a way that the object can be moved by the device at least temporarily along a rectilinear path.

5. The device according to claim 1, wherein the rotational movement of the carrier about the first axis of rotation (D₁) and the swivel movement of the swivel device about the second axis of rotation (D₂) can be superimposed on one another in such a way that
(a) the object can be transported from a receiving area to a position of use, and
(b) the object can be transported from the position of use to a delivery area.

6. The device according to claim 5, wherein the pick-up area corresponds to the delivery area.

7. The device according to claim 1, wherein a workpiece spindle for rotating the object, is arranged on the carrier, and wherein the swivel device is configured to transport the object, towards the workpiece spindle and away from the workpiece spindle.

8. The device according to claim 1, wherein the gripping device has two gripper arms, and the two gripper arms are configured to exert a clamping force on the object or to gripping underneath the object.

9. The device according to claim 1, wherein the carrier has a vertical or at least partially cylindrical, carrier tower.

10. The device according to claim 9, wherein the holder is arranged movably on the carrier tower or arranged axially movably on the carrier tower with respect to the first axis of rotation (D₁).

11. The device according to claim 9, wherein the second axis of rotation (D₂) is provided outside the carrier tower.

12. The device according to claim 1, further comprising a dressing device for dressing an abrasive of the grinding machine is arranged on the carrier.

13. The device according to claim 1, wherein the carrier is rotatable about the first axis of rotation (D₁) in such a way that the carrier is configured to assume a maintenance position, and the grinding machine or the device is configured to be maintained or manually loaded in the maintenance position.

14. The device according to claim 12,
wherein a workpiece spindle for rotating the object is arranged on the carrier, and
wherein the swivel device is configured to transport the object towards the workpiece spindle and away from the workpiece spindle,
wherein the carrier has a vertical or at least partially cylindrical, carrier tower, and
wherein the carrier tower has a first outer wall facing the workpiece spindle and a second outer wall facing the dressing device, and wherein the first outer wall is a side wall of the carrier tower opposite the second outer wall.

15. The device according to claim 1, further comprising a centering device for centering the object.

16. The device according to claim 1, wherein the device has a position-determining device for determining the position of the object, wherein the position-determining device comprises at least one sensor.

17. The device according to claim 16, wherein the carrier has a vertical or at least partially cylindrical, carrier tower, and
wherein the position-determining device is arranged on the carrier tower so as to be movable with respect to the first axis of rotation (D₁), or pivotable with respect to the first axis of rotation (D₁).

18. The device according to claim 1, the carrier comprises a reading unit for reading out information storage elements arranged on the object.

19. A grinding machine for gear grinding a workpiece or a pre-toothed workpiece, the grinding machine comprising:
(a) a machine housing,
(b) a grinding device arranged on the machine housing for grinding the workpiece,
(c) a device according to claim 1, wherein
(d) the machine housing of the grinding machine is the base of the device.

20. The grinding machine according to claim 19, wherein
(a) a dressing device for dressing an abrasive of the grinding device is arranged on the carrier,
(b) a workpiece spindle for rotating the workpiece about a third axis of rotation (D₃) is arranged on the carrier, and
(c) the carrier can is configured to be rotated back and forth, at least between a grinding position, in which the workpiece spindle faces the grinding device, and a dressing position, in which the dressing device faces the grinding device.

21. A method for loading and unloading a grinding machine with an object by a device according to claim 1, wherein the rotational movement of the carrier about the first axis of rotation (D₁) during a loading operation or during an unloading operation takes place at least at times simultaneously with the swivel movement of the swivel device about the second axis of rotation (D₂).

22. The method according to claim 21, wherein the carrier is rotated in a first direction of rotation about the first axis of rotation (D₁) and the swivel device is swivelled in a second direction of rotation opposite to the first direction of rotation about the second axis of rotation (D₂) when the rotational movement of the carrier and the swivel movement of the swivel device take place simultaneously.

23. (canceled)

24. (canceled)
